(19) United States
(12) Patent Application Publication
(10) Pub. No.: US 2018/0163313 A1
(43) Pub. Date: Jun. 14, 2018

(54) COMBINED MAGNETOHYDRODYNAMIC AND ELECTROCHEMICAL METHOD AND CORRESPONDING APPARATUS FOR PRODUCING HYDROGEN

(71) Applicant: HYDVILLE SYSTEMS LTD, Valletta (MT)

(72) Inventors: Pavol PETROVIC, Malacky (SK); Michal MASTENA, Bratislava (SK)

(21) Appl. No.: 15/852,096

(22) Filed: Dec. 22, 2017

Related U.S. Application Data
(63) Continuation-in-part of application No. 14/008,274, filed on Sep. 27, 2013, now abandoned.

(30) Foreign Application Priority Data
Apr. 21, 2011 (SK) PP 5022-2011

(51) Int. Cl. C25B 1/04; C25B 15/08; H02K 44/08; C25B 9/06; H01M 8/04119; H01M 8/0656

(52) U.S. Cl. CPC C25B 1/04; C25B 15/08; H02K 44/08; H01M 16/003; H01M 8/04156; H01M 8/0656; H01M 2250/402; C25B 9/06

(57) ABSTRACT

A combined magnetohydrodynamic and electrochemical method and corresponding apparatus that produces hydrogen leveraging water decomposition in a Spiral Magnetic Water Decomposer with electronic power supply circuit generating an AC sinusoidal electromagnetic signal with constant frequency and amplitude, overcoming the main disadvantage of electrolysis, the high level of energy consumption, increasing the efficiency of hydrogen production and keeping the environmental sustainability of the hydrogen production.

### CROSS-REFERENCE TO RELATED APPLICATIONS

The present application is a continuation-in-part of U.S. patent application Ser. No. 14/008,274, filed Sep. 27, 2013, which is a 35 U.S.C. § 371 national phase conversion of PCT/SK2012/050007, filed Apr. 20, 2012, which claims priority of Slovakia Patent Application No. PP 5022-2011, filed Apr. 21, 2011. The contents of each of these applications are incorporated in full by reference herein. The PCT International Application was published in the English language.

### FIELD OF THE INVENTION

The present invention relates to a combined magnetohydrodynamic and electrochemical method and corresponding apparatus for producing hydrogen. The aim of the present invention is to provide an alternative to the use of water electrolysis for hydrogen production, which would overcome the main disadvantage of electrolysis, the high level of energy consumption, increase the efficiency of hydrogen production and keep the environmental sustainability of the production. The invention falls within the field of energy and water management.

### BACKGROUND OF THE INVENTION

For the past 5 decades, environmentalists and several industrial organizations have promoted hydrogen fuel as the solution to the problems of air pollution and global warming. The key criteria for an ideal fuel are inexhaustibility, cleanliness, convenience, and independence from foreign control. Hydrogen possesses all these properties and is being evaluated and promoted worldwide as an environmentally benign replacement for gasoline, heating oil, natural gas, and other fuels in both transportation and no transportation applications (GUPTA, Ram B. (ed.). “Hydrogen fuel: production, transport, and storage.” Crc Press, 2008).

Similar to electricity, hydrogen is a high-quality energy carrier, which can be used with a high efficiency and zero or near-zero emissions at the point of use. It has been technically demonstrated that hydrogen can be used in transportation, heating, and power generation, and could replace current fuels in all their present uses. Hydrogen can be produced using a variety of starting materials, derived from both renewable and non-renewable sources, through many different process routes. At present, several basic process technologies are widely used: steam methane reforming process of natural gas, electrolysis of water, generating hydrogen from biomass or from gasification of coal.

The dominant industrial process used to produce hydrogen is the steam methane reforming process. It has been in use for several decades as an effective mean for hydrogen production. Steam methane reforming of natural gas is a mature technology, operating at or near the theoretical limits of the process that is used to produce nearly all the hydrogen (in the form of a mixture of hydrogen and carbon monoxide) in the chemical industry and the supplemental hydrogen in refineries (Adris A M, Pruden B B, Lim C J, Grace J R “On the reported attempts to radically improve the performance of the steam methane reforming reactor.” Can J Chem Eng 1996; 74:17). Steam methane reforming is a catalytic process that involves a reaction between natural gas or other light hydrocarbons and steam. The result is a mixture of hydrogen, carbon monoxide, carbon dioxide and water that is produced in a series of three reactions. There are fundamental disadvantages to obtaining hydrogen by reforming natural gas: using non-renewable energy source as an input raw material and the high production of CO2, ca. 7.05 kg CO2/kg H2.

The electrolysis of water is considered a well-known principle to produce oxygen and hydrogen gas. The core of an electrolysis unit is an electrochemical cell, which is filled with pure water and has two electrodes connected to an external power supply. At a certain voltage, which is called critical voltage, between both electrodes, the electrodes start to produce hydrogen gas at the negatively biased electrode and oxygen gas at the positively biased electrode. The amount of gases produced per unit time is directly related to the current that passes through the electrochemical cell (Zoulias, Emmanuel, et al. “A review on water electrolysis.” TCJST4.2 (2004): 41-71). There are several types of water electrolysis method: (1) alkaline fuel cell (AFC), (2) direct methanol fuel cell (DMFC), (3) molten carbonate fuel cell (MCFC), (4) phosphoric acid fuel cell (PAFC), (5) proton exchange membrane fuel cell (PEMFC), and (6) the solid oxide fuel cell (SOFC).

For the electrolysis of water, the standard reaction enthalpy is, ΔHo=285.8 (kJ/mol), Δn=1.5, ΔSo(H2)=130.6, ΔSo(O2)=205.1, ΔSo(H2O) (1)=70 J/mol K, ΔSotot=130.6+205.1ñ 70=163.14 J/mol K, and ΔAo=233.1 (kJ/mol). So, the minimum necessary cell voltage is Ecell=1.21 V. In the case of an open cell, Eocell=−ΔGo/nF=1.23 V, with ΔGo=ΔHo−TΔSo=237.2 kJ/mol (standard conditions, 1 bar, 25° C.). The value ΔGo=237.2 kJ/mol represent the minimum energy required to generate 1 mole of hydrogen gas. In fact, this value is higher because the industrial efficiency of electrolysers is below 80 percent. This is the main disadvantage using water electrolysis to generate hydrogen gas—a relatively large amount of energy consumed in the process of electrolysis. The advantage is that to supply electrolysis with energy, a variety of energy sources can be used including solar, wind, nuclear, biomass, petroleum, natural gas, and coal.

The main and undisputed benefit of water electrolysis is the use of water as a raw material. Moreover, water is considered a renewable energy source. Generated hydrogen is in the fuel cell again recombined to water that can be reused to electrolysis. Therefore, water is the most suitable source of hydrogen, and production is completely ecological.

Similar to electrolysis, our invention also uses water as an input raw material for the production of hydrogen. However, the decomposition of water in our invention is based on a different non-faradaic principle.

Our built-in Spiral Magnetic Water Decomposer (SMWD) reduces the energy intensity of water decomposition due to the combination of a static magnetic field and an alternating high-frequency electromagnetic field. Both these Maxwell fields deform the tetrahedral structure of water to such an extent that the hydrogen bonds between the water molecules and the covalent bonds between hydrogen and oxygen are disrupted to form hydrogen and oxygen gas.

It is important to point out that the hydrogen generation can be widely used within the electric power and heat production processes.

Known in the prior art is electric power generation based on hydrogen-oxygen reaction in a hydrogen fuel cell producing electric power, water and heat. Also known are various types of water electrolyses and electrolysers, such as PEM (Polymer Electrolyte Membrane) consisting of a membrane separating two metal electrodes. The membrane is made of a permeable polymer dissociating upon contact with water and becoming permeable for positive ions. The electrodes are made of platinum acting also as a water decomposition catalyst. Water is fed to the anode, where water molecules surrender their electrons and dissociate to oxygen O₂, positive hydrogen ions 4H⁺ and four free electrons. Produced oxygen together with unreacted water is collected in the anode flow channel. Free electrons are carried away by an applied external unidirectional electric field, i.e. the positive pole of a voltage source connected to the anode. Produced hydrogen ions H⁺ are transported through the membrane in the electric field to the cathode where they receive electrons providing a source of voltage and are reduced to hydrogen gas that is then drained away.

With respect to the claimed method of connecting the facilities into an integrated autonomous electric power generating system it is necessary to point out the processing of heat as an additional output from the PEM fuel cell, where for example the heat produced by the PEM hydrogen fuel cell can be turned into electric power as described in US Patent Application 20060216559 by using the coolant liquid circulating between two separate PEM hydrogen fuel cells.

Another type of an electrolytic cell is described in U.S. Pat. No. 4,105,528. the decomposition apparatus comprises a cathode and an anode arranged in vorticals not touching each other. This technology represents a low efficiency solution because based on the prior knowledge the device configured according to the patent requires more electric power to create a sufficiently strong magnetic field than conventionally used electrolysis facilities.

Our U.S. patent application Ser. No. 14/008,274 discloses a process of water decomposition to hydrogen and oxygen taking place in a spiral magnetic electrolyser powered by electrical pulses and fitted with permanent magnets at the water. The Spiral Magnetic Water Decomposer according to the present application comprises the same technical features as the water decomposition apparatus according to our U.S. patent application Ser. No. 14/008,274, the difference being the AC sinusoidal electromagnetic signal generated by the electronic power supply unit.

Subsequently, the main goal of the invention, to provide an alternative to the use of water electrolysis for hydrogen production, which would overcome the main disadvantage of electrolysis, the high level of energy consumption, increase the efficiency of hydrogen production and keep the environmental sustainability of the production is solved in the Spiral Magnetic Water Decomposer of the present invention, leveraging the AC sinusoidal electromagnetic signal generated by the electronic power supply unit as explained further.

### SUMMARY OF THE INVENTION

The invention is explained further with reference to the accompanying figures.

A water molecule 100 consists of one atom of oxygen 101 and two hydrogen 102 atoms (FIG. 1a). Between oxygen and hydrogen is a covalent bond, with internuclear distance 0.0965 nm. The oxygen atom 101 has two other free electron pairs 110 that form a water molecule in tetrahedral structures (FIG. 1b). In this structure, the two covalent OH bonds 111 are at an angle of 104.45° to each other. Since the electric charge of free electron pairs of oxygen is in the negative electric charge and the hydrogen atoms have a positive charge, the water molecule has a dipole moment of permanently size μ=6,13.10−30 C×m. Interactions of dipole moments of individual water molecules form weak electrostatic hydrogen bonds 112 between water molecules with 0.177 nm average length. This association of molecules produces large clusters of water molecules of different sizes (FIG. 1d). As mentioned, the water molecule has a tetrahedral structure as shown in the FIG. 1b. The center of the tetrahedron is an oxygen atom 101 and at its vertices, there are hydrogen atoms 102 and free electron oxygen pairs 110. The geometry of the oxygen p-electrons is likely to determine the vectors towards the hydrogen atoms 113 (H1, H2) and the vectors towards the free electron pair of oxygen 114 (L1, L2), which subsequently determine the tetrahedral structure of the water molecule (FIG. 1c).

The electrons are responsible for forming the covalent bond. The position of an electron cannot be determined, only the probability of its occurrence can be determined. The area in which its probability of occurrence is the highest is called the atomic orbital. The overlap of oxygen and hydrogen atomic orbitals leads to create a covalent bond. The shape and size of atomic orbitals determine electron interaction with the atomic nucleus. Once the covalent bond is formed, the shape of the atomic orbital and thus the entire molecule also changes. Just like the water molecule has the shape of a tetrahedron.

The Spiral Magnetic Water Decomposer (SMWD) 200 is designed to disrupt the tetrahedral structure of water (FIG. 1b), causing the hydrogen bonds 112 to break between each water molecule and breaking the covalent bonds 111 between the oxygen and hydrogen atoms. This leads to a generation of H₂ and O₂ gases. The SMWD 200 consists of a body of the decomposer 201, two spiral electrodes (also referred as “spirally configured electrodes” further on) 202 and permanent magnetic segments that generate static magnetic field in the space between spiral electrodes (FIG. 2). The water inlet 204 and outlet 205 apertures are located on the bottom and top of the decomposer. Top aperture 205 also serves as the exhaust generated hydrogen and oxygen gases.

The main component of Spiral Magnetic Water Decomposer are two spiral 202 electrodes that have been manufactured using the latest technologies, such as 3D printing, allowing to reach the minimal mutual distance between the electrodes. However, other technologies, providing the same results might be used. Spiral electrodes 202 are made of a paramagnetic material; their mutual distance is only 0.4 mm (FIG. 3). The spiral electrodes 202 are located inside the SMWD body and are submerged under water level when the SWMD is used. The external terminations of the spiral electrodes 206 pass through the body of the decomposer into the external environment. These terminations of spiral electrodes are used to connect an electronical power supply circuit 210.

On the outside of the SMWD body 201, permanent magnetic segments 203 are located. This system of magnets 202 generates a strong static magnetic field in the spiral electrode region. The number and location of the magnetic segments and the arrangement of the magnetic poles of the magnetic segments is selected so that the magnetic field lines pass through the space in-between spiral electrodes. The type, number of magnets, shape of the magnets and exact location of them is not important, as long they generate the required magnetic field. Because the electrodes 202 are of the paramagnetic material, they do not interact with the magnetic field and thus do not affect the flux of magnetic field lines. Generated static magnetic field only effects on the structure of water.

Because the water is diamagnetic, the stationary magnetic field has a significant impact on its physicochemical properties (Cai, Ran, et al. “The effects of magnetic fields on water molecular hydrogen bonds.” Journal of Molecular Structure 938.1 (2009): 15-19). The magnetic field brought down the surface tension of water while promoted the viscosity at 298 K. It was suggested that the water intermolecular energy decreased, activation energy increased and rotational motions of water molecules got slow.

Interaction of static magnetic field with the magnetic moment of water molecule 100 strongly affects the hydrogen bond 112 distribution. The external magnetic field weakens or even partly breaks a hydrogen bond 112 and increases the number of monomer water molecules (Zhou, K. X., et al. “Monte Carlo simulation of liquid water in a magnetic field.” Journal of Applied Physics 88.4 (2000): 1802-1805. APA).

This all described interaction of static magnetic field with water dramatically decrease the energy needed for water molecule decomposition.

An essential element of SMWD 200 is not only the decomposer structure itself, the arrangement of electrodes 202 and the configuration of permanent magnets 203 but also the electronic power supply circuit 210. The electronic power supply circuit 210 generates an AC sinusoidal electromagnetic signal with constant frequency and amplitude that is fed to the spiral electrodes 202. It is not important for the invention, which type of power supply circuit is used, as long it generates the required signal. This electronic circuit 210 act as transmitter and is designed so that no unidirectional electric current passes between the spiral electrodes 202. In this arrangement, a classic DC electrolysis does not occur, where the oxidation takes place on the anode and the reduction to the cathode to produce O2 or H2 gases. Electrodes 202 in our case are used to generate an electromagnetic signal (radiation) that is emitted into the water.

The electromagnetic waves (radiation) generated by the spiral electrodes 202 act on the tetrahedral structure of the water molecule 100. The first effect is on the proton vectors H1 and H2 113. These proton vectors respond to cyclical changes in the amplitude of the carrier frequency and its associated sub-frequency bands, which are generated by spiral electrodes 202. This causes the rotation of the proton magnetic moment (spin). The change of proton magnetic moment results to change of overall nuclear magnetic moment. The magnetic moment of the atomic nucleus interacts with the magnetic moment of the electrons and the orbital magnetic moment. This interaction determines the energy state of the atom. The hydrogen atom 103 may e.g. to move from the basic singlet state to a triplet excited state. This weakens the covalent bond 111 between hydrogen atom 103 and oxygen atom 102 and reducing the energy requirements for the decomposition of water. A similar principle with an alternating magnetic field combination is also used in the nuclear magnetic resonance.

In order to further exacerbate the decomposition of water, it is advisable to apply a signal of another frequency to the spiral electrodes 202. The carrier frequency is processed using the heterodyning technique. Any technique providing the same effect might be used however. The modulated sinusoidal carrier frequency then contains higher harmonic frequencies. Using this approach, it is possible to apply to the water countless harmonics frequencies using one supply circuit. It is preferred to use a heterodyne signal with a third or sixth harmonic frequency to the carrier frequency. Such a heterodyne high-frequency electromagnetic signal even further affects the proton vectors H1 and H2 113 and the proton magnetic moment.

The frequency of base carrier electromagnetic waves that is transmitted through spiral electrodes 202 to water depends on the purity of the water. For a generation of hydrogen gas, ultrapure water with conductivity below 0.1 μS/cm is used in the SMWD 200. It is possible to use water of any purity. The high purity water but ensures that the electromagnetic signal (radiation) to interact only with a molecule of water.

### BRIEF DESCRIPTION OF THE DRAWINGS

FIGS. 1a-1d show the structure of water molecule. The water molecule 100 consists of one atom of oxygen 101 and two hydrogen 102 atoms (FIG. 1a). The oxygen atom has two other free electron pairs 110 that form a water molecule in tetrahedral structures (FIG. 1b). The geometry of the oxygen p-electrons is likely to determine the vectors towards the hydrogen atoms 113 (H1, H2) and the vectors towards the free electron pair of oxygen 114 (L1, L2), which subsequently determine the tetrahedral structure of the water molecule (FIG. 1c).

In this structure, the two covalent OH bonds 111 are at an angle of 104.45° to each other. Since the electric charge of free electron pairs of oxygen is in the negative electric charge and the hydrogen atoms have a positive charge, the water molecule has a dipole moment of permanently size μ=6,13.10-30 C×m. Interactions of dipole moments of individual water molecules form weak electrostatic hydrogen bonds 112 between water molecules with 0.177 nm average length. This association of molecules produces large clusters of water molecules of different sizes (FIG. 1d).

FIG. 2 shows the structure of Spiral Magnetic Water Decomposer (SMWD) according to the preferred embodiment. The SMWD 200 consists of a body of the decomposer 201, two spiral electrodes 202 and two pairs of neodymium toroidal semicircles segments 203. The water inlet 204 and outlet 205 aperture are located on the bottom and top of the decomposer. Top aperture 205 also serves as the exhaust generated hydrogen and oxygen gases. The permanent toroidal magnets 203 are located above and below the spiral electrodes 202 on the outside of the SMWD body 201. Each toroid 203 is made up of two semicircular segments. The toroid is magnetized diametrically perpendicular to the vertical axis of the SMWD 200. There is a different magnetic pole on the outer side and on the inner of the semicircular segment.

FIG. 3 shows the spiral electrodes according to the preferred embodiment. Spiral electrodes 202 are located inside the SMWD body and are submerged under water level. Spiral electrodes 202 are manufactured using the latest technologies, such as 3D printing, allowing to reach minimal mutual distance between the electrodes. However, other technologies, providing the same results might be used. Spiral electrodes 202 made paramagnetic material are inserted into each other and do not touch any space at any point. The external terminations of the electrodes 206 pass through the body of the decomposer into the external environment. These terminations of spiral electrodes are used to connect an electrical supply circuit 210. Spiral electrodes 202 generate an alternating magnetic field, as they are connected to the electronic power supply circuit 210, similar to the coil.

FIG. 4 shows the Spiral Magnetic Water Decomposer according to the preferred embodiment with electronic power supply circuit. The electronic power supply circuit 210 generates a AC sinusoidal electromagnetic signal (radiation) with constant frequency and amplitude that is fed to the external terminations of the spiral electrodes 206. This electronic circuit 210 act as transmitter and is designed so that no unidirectional electric current passes between the spiral electrodes 202.

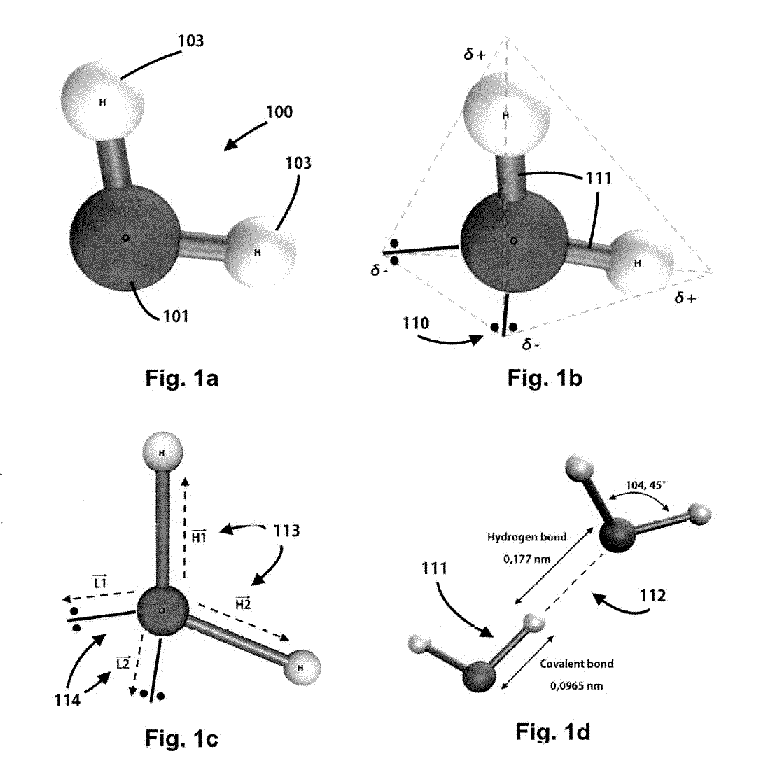

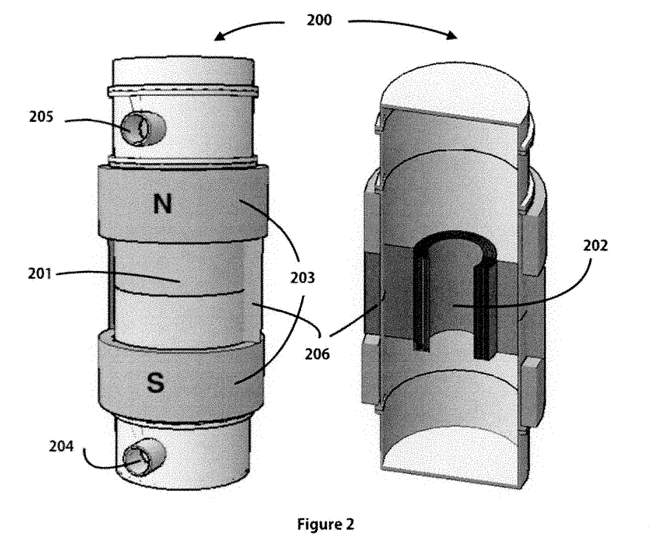

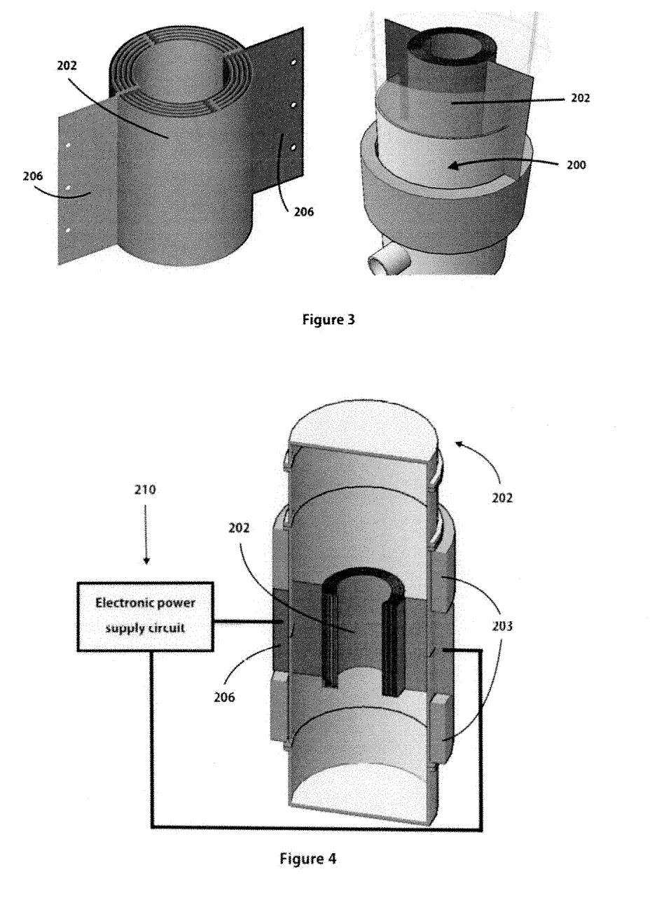

The electronic power supply circuit 210 can generate a simple AC sinusoidal electromagnetic signal, as well as a heterodyne signal that includes higher harmonics in addition to the carrier frequency. The connection of the transmitting circuit to the spiral electrodes 202 requires precise impedance matching because the impedance of the water varies with frequency and purity, as known to expert in the art.

### DESCRIPTION OF THE PREFERRED EMBODIMENTS

It is understood that the individual embodiments of corresponding apparatus for producing hydrogen according to the present invention are shown by way of illustration only and not as limitations. Those skilled in the art will recognize, or be able to ascertain using no more than routine experimentation, many equivalents to the specific embodiments of the invention. Such equivalents are intended to be encompassed by the following claims.

Those skilled in the art would have no problem dimensioning the apparatus for producing hydrogen and choosing suitable materials and design configurations, which is why these features were not designed in detail.

### Example 1

This example of a specific embodiment of the present invention describes the preferred embodiment of the Spiral Magnetic Water Decomposer for producing hydrogen.

The Spiral magnetic water decomposer (SMWD) 200 consists of a body of the decomposer 201, two spiral electrodes 202 and two pairs of neodymium toroidal semicircle segments 203. In the preferred embodiment, the body of an SMWD 202 is made of polymeric material so that in any case did not affect the magnetic field. The water inlet 204 and outlet 205 aperture are located on the bottom and top of the decomposer. Top aperture 205 also serves as the exhaust generated hydrogen and oxygen gases.

The permanent toroidal magnets 203 are made from Neodymium material and are located above and below the spiral electrodes 202 on the outside of the SMWD body 201. Each neodymium toroid 203 is made up of two semicircular neodymium segments. The neodymium toroid is magnetized diametrically perpendicular to the vertical axis of the SMWD 200. There is a different magnetic pole on the outer side and on the inner of the semicircular segment.

Two spiral 202 electrodes are manufactured from paramagnetic titanium using the latest 3D printing method. The mutual distance between spiral electrodes is only 0.4 mm. The spiral electrodes are inserted into each other and do not touch at any point. They are located inside the SMWD body and are submerged under water level that is fed into the spiral electrodes environment via the water inlet 204, when the SWMD is used. For a generation of hydrogen gas, ultrapure water with conductivity 0.05 μS/cm is used in the SMWD 200.

The external terminations of the spiral electrodes 206 pass through the body of the decomposer into the external environment. These terminations of spiral electrodes 202 are used to connect an electronic power supply circuit 210.

The electronic power supply circuit 210 generates a AC sinusoidal electromagnetic signal with constant frequency and amplitude. The carrier wave frequency is in the UHF region of the electromagnetic spectrum. The generated AC sinusoidal electromagnetic signal has a zero DC component (it has a zero mean value). In this case, no unidirectional electric current passes between the spiral electrodes 202. In this arrangement, a classic DC electrolysis does not occur. An electromagnetic signal is emitted by spiral electrodes into water, where it ultimately, in combination with a static magnetic field, causes the decomposition of water.

### INDUSTRIAL APPLICABILITY

The combined magnetohydrodynamic and electrochemical method and corresponding apparatus for producing hydrogen according to the present invention can be applied broadly in the energy and water management industries. It can be more specifically, but not only used as efficient and environmentally sustainable source of hydrogen in hydrogen fuel cells leveraged in electric power generating system.

1. Spiral magnetic water decomposer comprising a body with an inlet and an outlet, two spirally configured electrodes, a plurality of permanent magnets arranged such as the magnetic field lines pass thru the space in between spirally configured electrodes, and an electronic power supply circuit,
wherein the electronic power supply circuit is generating an AC sinusoidal electromagnetic signal with constant frequency and amplitude that is fed to the spirally configured electrodes.

2. Spiral magnetic water decomposer according to claim 1, wherein the frequency of the AC sinusoidal electromagnetic signal is in the UHF region.

3. Spiral magnetic water decomposer according to claim 1, wherein the AC sinusoidal electromagnetic signal with constant frequency and amplitude comprises higher harmonic frequencies.

4. Spiral magnetic water decomposer according to claim 1, wherein the permanent magnets are located at the inlet and at the outlet of the spiral magnetic water decomposer.

5. Spiral magnetic water decomposer according to claim 1, wherein the plurality of permanent magnets are two permanent magnets.

6. Spiral magnetic water decomposer according to claim 1, wherein the permanent magnets are toroidal permanent magnets.

7. Spiral magnetic water decomposer according to claim 1, wherein the permanent magnets are neodymium permanent magnets.

8. Combined magnetohydrodynamic and electrochemical method for producing hydrogen, wherein the hydrogen as the main product is produced by using a process of decomposing water to hydrogen and oxygen in a spiral magnetic water decomposer according to claim 1, wherein water is fed into the spiral magnetic decomposer via the inlet and the spirally configured electrodes are submerged under the water surface.

9. Combined magnetohydrodynamic and electrochemical method for producing hydrogen according to claim 8, wherein water with conductivity below 0.1 μS/cm is used.

10. Combined magnetohydrodynamic and electrochemical method for producing hydrogen according to claim 9, wherein water with conductivity of 0.05 μS/cm is used.

11. A method of electric power generation leveraging a hydrogen power cell, wherein the hydrogen is produced using the method according to claim 8.
